(19) United States
(12) Patent Application Publication
(10) Pub. No.: US 2003/0115289 A1
(43) Pub. Date: Jun. 19, 2003

(54) Navigation in a voice recognition system

(76) Inventors: Garry Chinn, San Mateo, CA (US); Sven H. Khatri, Oakland, CA (US)

Correspondence Address: Philip W. Woo, SKJERVEN MORRILL MacPHERSON LLP, 28th Floor, Three Embarcadero Center, San Francisco, CA, 94111, US

(21) Appl. No.: 10/022,626

(22) Filed: Dec. 14, 2001

(51) Int. Cl. G06F 15/16

(52) U.S. Cl. 709/219

(57) ABSTRACT

Systems and corresponding methods are provided for navigating a data structure comprising a plurality of nodes. Each node in the data structure is associated with content from a content source and at least a keyword defining the content. The system receives a voice query to access content in one of the plurality of nodes. The system then recognizes one or more search keywords in the voice query based on a navigation grammar defined by a first active navigation scope associated with a first set of nodes in the data structure. The system then searches the first set of nodes to find a node with one or more keywords that best match the search keywords. The node that best matches the search keywords is then visited. The system provides content of the visited node.

### RELATED APPLICATIONS

The present Application is related to U.S. Patent Application number UNKNOWN (Attorney Matter No. M-9333 US), filed Jul. 26, 2001, entitled “System and Method for Browsing Using a Limited Display Device,” and U.S. patent application Ser. No. 09/614,504 (Attorney Matter No. M-8247 US), filed Jul. 11, 2000, entitled “System And Method For Accessing Web Content Using Limited Display Devices,” with claims of priority under 35 U.S.C. §119(e) to Provisional Application No. 60/164,429, filed Nov. 9, 1999, entitled “Method For Accessing Network Data on Telephone and Other Limited Display Devices.” The entire content of the above-referenced applications is incorporated by reference herein.

### COPYRIGHT & TRADEMARK NOTICE

A portion of the disclosure of this patent document contains material, which is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and shall not be construed as descriptive or limit the scope of this invention to material associated only with such marks.

### BACKGROUND

1. Field of the Invention

The invention relates generally to data communications and, in particular, to navigation in a voice recognition system.

2. Related Art

With advancements in communications technology, content is available via voice operated systems that translate voice commands into system commands for data retrieval. Such systems are generally referred to as voice recognition systems.

A voice recognition system recognizes vocalized commands or utterances provided by a user. Typically, a navigation grammar (also sometimes referred to as recognition grammar) defines the boundaries of utterances that can be recognized by the voice recognition system. Accuracy in recognition depends on various system and human related factors, such as voice quality, sophistication of the voice recognition system, and the perplexity of the voice recognition grammar.

Some of the current voice recognition systems achieve adequate voice recognition accuracy only in highly controlled and limited environments. That is, most current voice recognition systems are designed to provide a user with immediate access to content under a small number of categories, such as, for example, telephone number listings or bank account information.

Current systems, however, lack the sophistication to efficiently provide a user with access to a wide variety of information available in many different categories and from disparate sources, such as web pages on the Internet. With current systems, such information must be divided into a number of categories or subcategories which are organized subject to a logical hierarchical order. A user is then forced to follow a very specific virtual route along the categories and subcategories in order to access the information that he or she desires.

This routing process is particularly arcane and undesirable when a user needs to access various content classified under a number of different categories. To access a first content classified under a hierarchy of categories, a user may have to navigate a first route starting from a main category through all sub-categories. To access a second content in another category, the user may be required to traverse backwards through the first route back to the main category and then down a second route leading to the second content.

In concept, data structures used to store content in different categories are similar to trees, where each tree branch defines a category or subcategory. Content may be found at the end of each branch. Obviously, a greater volume of content translates into a large number of content categories, fostering more branches in the tree. One can imagine the difficulty and confusion associated with traversing back and forth through many branches in a highly branched data structure.

In general, the perplexity of a navigation grammar for accessing content is directly related to the complexity of the data structure storing the content. As such, a navigation grammar for a highly branched data structures can be highly perplex. Unfortunately, as the perplexity increases, the voice recognition accuracy and efficiency decreases. More efficient systems and methods for accessing content in a complex voice recognition environment are desirable.

### SUMMARY

Systems and corresponding methods for navigating content included in a data structure comprising a plurality of nodes are provided. The nodes in the data structure are linked in a predefined hierarchical order. Each node is associated with content from a content source and at least a keyword defining or characterizing the content. Any node can be “visited” by a user in order to access the content from that node. One or more navigation grammars are each defined by at least some portion of the keywords included in the nodes and can be utilized by a user to navigate the data structure by way of issuing voice commands or queries.

To navigate the data structure, the system receives a voice query from a user who wishes to visit a node in the data structure. Once a node is visited then the user can access the content included in that node. In one embodiment, one or more navigation modes can be provided for navigating the data structure. Each navigation mode is associated with a respective navigation grammar. Each navigation grammar may be defined by a respective set of keywords and corresponding navigation rules. A user may switch between different navigation modes in order to facilitate or optimize his/her experience while navigating the data structure. The set of keywords for each grammar may be defined, expanded, or reduced during navigation. Exemplary navigation modes include: Step mode, Stack mode, and Rapid Access Navigation (RAN) mode.

In the Step mode, the navigation grammar includes keywords that are included in a default grammar, in addition to keywords included in the nodes that are directly linked to the currently visited node. In the Stack mode, the navigation grammar in addition to the above-mentioned keywords may also include keywords included in all nodes previously visited by the user. In the RAN mode, the navigation grammar includes keywords included in an active navigation scope. The navigation scope is defined by a set of nodes in the data structure.

RAN mode may be invoked by one or more directives. A directive may begin with a prefix phrase or keyword which is followed by one or more filler words or phrases. A directive also includes one or more search keywords. In one embodiment, word spotting or other equivalent techniques may be used to identify search keywords while rejecting filler words.

In accordance with one aspect of the invention, once a user query is received by the system, the system then recognizes one or more search keywords in the voice query based on a navigation grammar defined by the navigation mode presently in effect. The nodes in the data structure are organized in a hierarchy or tree by links. The system then searches the nodes in an active navigation scope to find a node with keywords that best match the search keywords. The best match is determined by matching the search keywords with the keywords of the node and the keywords of the node's ancestors. The node that best matches the search keywords is then visited. The system then provides content included in the visited node to the user, for example, in an audio format.

In one embodiment, scores are assigned to nodes according to match with keywords. If two or more nodes are tied for the highest score, the system performs a disambiguation process. In the disambiguation process, the user is prompted to select one of the nodes. In some embodiments, the system may determine that the RAN query is ambiguous if the highest matching score does not exceed some chosen threshold. This threshold may be an absolute value or it may be a value relative to the next highest matching score. In the case where this threshold is not exceeded, the system may initiate the disambiguation process.

In accordance with one aspect of the invention, the nodes are organized in a tree data structure. Each node in the tree data structure is linked to one or more ancestral nodes in a hierarchical relationship defined by links. Each node contains one or more node keywords. In some embodiments, one or more matching scores may be computed for every node. For a given node in the tree data structure, a node indicator corresponds to the number of search keywords that match its node keywords. For a given node, an ancestral indicator corresponds to the number of search keywords that match the node keywords in any of its ancestors nodes.

In one or more embodiments, if none of the nodes in the data structure match all of the search keywords, the system finds a first node and a second node in the data structure that match the highest number of search keywords. The system then associates the first node with a first node indicator that represents the number of the search keywords included in the first node, in a first order. A second node indicator is also associated with the second node to represent the number of search keywords included in the second node, in the first order. The system then compares the first node indicator with the second node indicator.

In certain embodiments, each node is associated with a node indicator so that the system can compare all node indicators to determine which nodes include the highest number of search keywords. Once the node with the highest number of search keywords is found, then the system provides the content included in that node. In the above example, after the system compares the node indicators for the first and the second nodes, then the system provides content included in the first node, if the first node indicator is greater than the second node indicator. Otherwise, the system provides the content included in the second node, if the first node indicator is less than the second node indicator.

If the first node indicator is equal to the second node indicator, the system determines a first ancestral indicator and a second ancestral indicator for the second node. The system then compares the first ancestral indicator with the second ancestral node indicator. Thereafter, the system provides content included in the first node, if the first ancestral indicator is greater than the second ancestral node indicator, and the content included in the second node, if the first ancestral indicator is less than the second ancestral node indicator.

In some embodiments, the system calculates a first cumulative indicator from the first node indicator and the first ancestral indicator. The first cumulative indicator represents the number of keywords included in the first node and the first set of ancestral nodes. A second cumulative indicator is calculated from the second node indicator and the second ancestral indicator. The second cumulative indicator represents the number of search keywords included in the second node and the second set of ancestral nodes.

In certain embodiments, the indicators are binary numbers and the cumulative indicator for a node is derived from a logical AND operation applied to corresponding digits included in the node indicator and the ancestral indicator for that node. Once the cumulative indicators are calculated, the system provides content included in the first node, if the first cumulative indicator is greater than the second cumulative indicator; and the content included in the second node, if the first cumulative indicator is less than the second cumulative indicator.

### BRIEF DESCRIPTION OF THE DRAWINGS

FIG. 1 illustrates an exemplary environment in which a voice navigation system, according to an embodiment of the invention, may operate.

FIG. 2 is a block diagram illustrating an exemplary navigation tree.

FIG. 3 is a flow diagram illustrating a method for processing a user query, in accordance with one or more embodiments.

FIG. 4 is a flow diagram illustrating a method for finding the best matching node in a data structure for a voice query, in accordance with one or more embodiments.

FIG. 5 is a flow diagram illustrating a method for resolving ambiguities in a voice recognition system, in accordance with one or more embodiments.

FIG. 6 is an block diagram illustrating an exemplary software environment suitable for implementing the voice navigation system of FIG. 1.

FIG. 7 illustrates a computer-based system which is an exemplary hardware implementation for the voice navigation system of FIG. 1.

Features, elements, and aspects of the invention that are referenced by the same numerals in different figures represent the same, equivalent, or similar features, elements, or aspects in accordance with one or more embodiments of the system.

### DETAILED DESCRIPTION

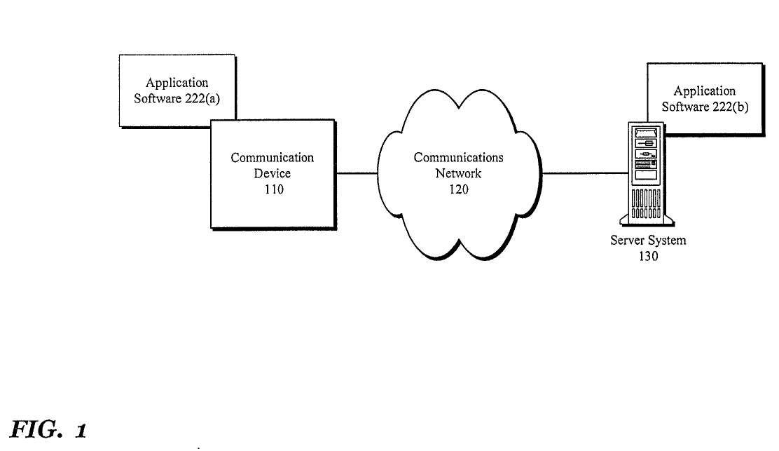

The invention and its advantages, according to one or more embodiments, are best understood by referring to FIGS. 1-7 of the drawings. Like numerals are used for like and corresponding parts of the various drawings. The invention, its advantages, and various embodiments are provided in detail below.

Information management systems and corresponding methods, according to one or more embodiments of the invention, facilitate and provide electronic services for navigating a data structure for content. The terms “electronic services” and “services” are used interchangeably through out this description. An online service provider provides the services of the system, in one or more embodiments. A service provider is an entity that operates and maintains the computing systems and environment, such as server system and architectures, which process and deliver information. Typically, a server architecture includes the infrastructure (e.g., hardware, software, and communication lines) that offers the electronic or online services.

These services provided by the service provider may include telephony and voice services, including plain old telephone service (POTS), digital services, cellular service, wireless service, pager service, voice recognition, and voice user interface. To support the delivery of services, the service provider may maintain a system for communicating over a suitable communication network, such as, for example, a communications network 120 (FIG. 1). Such communications network allows communication via a telecommunications line, such as an analog telephone line, a digital T1 line, a digital T3 line, or an OC3 telephony feed, a cellular or wireless signal, or other suitable media.

In the following, certain embodiments, aspects, advantages, and novel features of the system and corresponding methods have been provided. It is to be understood that not all such advantages may be achieved in accordance with any one particular embodiment. Thus, the invention may be embodied or carried out in a manner that achieves or optimizes one advantage or group of advantages as taught herein without necessarily achieving other advantages as may be taught or suggested herein.

Nomenclature

The detailed description that follows is presented largely in terms of processes and symbolic representations of operations performed by conventional computers, including computer components. A computer may comprise one or more processors or controllers (i.e., microprocessors or microcontrollers), input and output devices, and memory for storing logic code. The computer may be also equipped with a network communication device suitable for communicating with one or more networks.

The execution of logic code (i.e., software) by the processor causes the computer to operate in a specific and predefined manner. The logic code may be implemented as one or more modules in the form of software or hardware components and executed by a processor to perform certain tasks. Thus, a module may comprise, by way of example, of software components, processes, functions, subroutines, procedures, data, and the like.

The logic code conventionally includes instructions and data stored in data structures resident in one or more memory storage devices. Such data structures impose a physical organization upon the collection of data bits stored within computer memory. The instructions and data are programmed as a sequence of computer-executable codes in the form of electrical, magnetic, or optical signals capable of being stored, transferred, or otherwise manipulated by a processor.

It should also be understood that the programs, modules, processes, methods, and the like, described herein are but an exemplary implementation and are not related, or limited, to any particular computer, apparatus, or computer programming language. Rather, various types of general purpose computing machines or devices may be used with logic code implemented in accordance with the teachings provided, herein.

System Architecture

Referring to the drawings, FIG. 1 illustrates an exemplary environment in which the invention according to one embodiment may operate. In accordance with one aspect, the environment comprises at least a server system 130 connected to a communications network 120. The terms “connected,” “coupled,” or any variant thereof, mean any connection or coupling, either direct or indirect, between two or more elements. The coupling or connection between the elements can be physical, logical, or a combination thereof.

Communications network 120 may include a public switched telephone network (PSTN) and/or a private system (e.g., cellular system) implemented with a number of switches, wire lines, fiber-optic cables, land-based transmission towers, and/or space-based satellite transponders. In one embodiment, communications network 120 may include any other suitable communication system, such as a specialized mobile radio (SMR) system.

As such, communications network 120 may support a variety of communications, including, but not limited to, local telephony, toll (i.e., long distance), and wireless (e.g., analog cellular system, digital cellular system, Personal Communication System (PCS), Cellular Digital Packet Data (CDPD), ARDIS, RAM Mobile Data, Metricom Ricochet, paging, and Enhanced Specialized Mobile Radio (ESMR)).

Communications network 120 may utilize various calling protocols (e.g., Inband, Integrated Services Digital Network (ISDN) and Signaling System No. 7 (SS7) call protocols) and other suitable protocols (e.g., Enhanced Throughput Cellular (ETC), Enhanced Cellular Control (EC2), MNP10, MNP10-EC, Throughput Accelerator (TXCEL), and Mobile Data Link Protocol). Transmission links between system components may be analog or digital. Transmission may also include one or more infrared links (e.g., IRDA).

Communications network 120 may be connected to another network such as the Internet, in a well-known manner. The Internet connects millions of computers around the world through standard common addressing systems and communications protocols (e.g., Transmission Control Protocol/Internet Protocol (TCP/IP), HyperText Transport Protocol (HTTP)), creating a vast communications network.

One of ordinary skill in the art will appreciate that communications network 120 may advantageously be comprised of one or a combination of other types of networks without detracting from the scope of the invention. Communications network 120 can include, for example, Local Area Networks (LANs), Wide Area Networks (WANs), a private network, a public network, a value-added network, interactive television networks, wireless data transmission networks, two-way cable networks, satellite networks, interactive kiosk networks, and/or any other suitable communications network.

Communications network 120, in one or more embodiments, connects communication device 110 to server system 130. Communication device 110 may be any voice-based communication system that can be used to interact with server system 130. Communication device 110 can be, for example, a wired telephone, a wireless telephone, a smart phone, or a wireless personal digital assistant (PDA). Communication device 110 supports communication by a respective user, for example, in the form of speech, voice, or other audible manner capable of exchanging information through communications network 120. Communication device 110 may also support dual tone multi-frequency (DTMF) signals.

Server system 130 may be associated with one or more content providers. Each content provider can be an entity that operates or maintains a service through which audible content can be delivered. Content can be any data or information that is audibly presentable to users. Thus, content can include written text (from which speech can be generated), music, voice, and the like, or any combination thereof. Content can be stored in digital form, such as, for example, a text file, an audio file, etc.

In one or more embodiments of the system, application software 222 is implemented to execute fully or partially on server system 130 to provide voice recognition and voice interface services. In some embodiments, application software 222 may advantageously comprise a set of modules 222(a) and 222(b) that can operate in cooperation with one another, while executing on separate computing systems. For example module 222(a) may execute on communication device 110 and module 222(b) may execute on server system 130, if application software 222 is implemented to operate in a client-server architecture.

As used herein, the term server computer is to be viewed as designations of one or more computing systems that include server software for servicing requests submitted by devices or other computing systems connected to communications network 120. Server system 130 may operate as a gateway that acts as a separate system to provide voice services. Content may be stored on other devices connected to communications network 120. In other embodiments, server system 130 may provide the voice interface services as well as content requested by a user. Thus, server system 130 may also function to provide content. The terms server or server software are not to be limiting in any manner.

Application Software for Voice Navigation

In accordance with one aspect of the invention, content available from various sources is organized under certain identifiable categories and sub-categories in a data structure. The content is included in a plurality of nodes. It should be understood that, in general, content or information are physically stored in electrically, magnetically, or optically configurable storage mediums. However, content may be deemed to be “included” in or associated with a node in a data structure if the logical relationship between the data structure and the content provides a computing system with the means to access the information in the medium in which the content is stored.

The nodes are logically linked to one another to form a data structure. The logical links provide one or more associations between the nodes. These associations or links define the hierarchical relationship between the nodes and the content that is stored in the nodes.

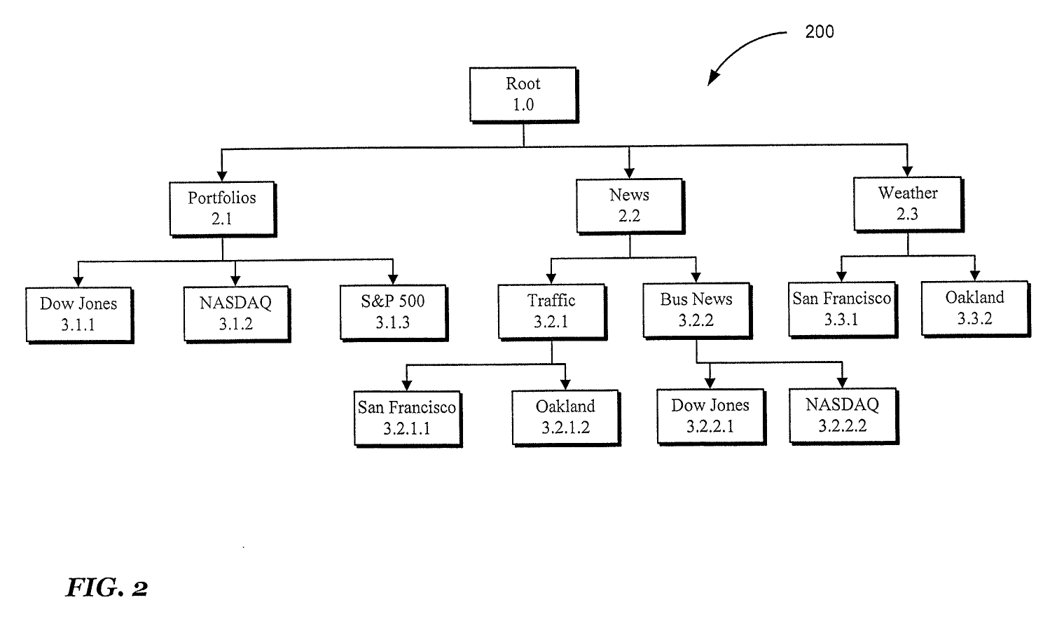

FIG. 2 is a block diagram illustrating an exemplary navigation tree. In particular, FIG. 2 illustrates an exemplary data structure 200 that includes a plurality of nodes (e.g., nodes 1.0, 2.1, 2.2, etc.) hierarchically organized into a number of content categories (e.g., Portfolios, News, Weather, etc.). A root node 1.0 is the common hierarchical node for all the nodes in data structure 200. Each node includes or is associated with one or more keywords that define the content or the order of a node within data structure 200. For example, Node 3.2.1.1 is associated with the keyword “San Francisco” and includes content associated with traffic news in the San Francisco area; Node 2.2 is associated with the keyword “News” and includes no content.

Nodes that contain content are referred to as content nodes. Intermediary nodes that link the content nodes to the root node are referred to as hierarchical nodes. A hierarchical node that is higher in the hierarchy than another node is the ancestral node for that node. The nodes that are lower in the hierarchy are the descendants of the node. The hierarchical nodes define the hierarchical relationship between the nodes in data structure 200. The hierarchical nodes are sometimes referred to as routing nodes, and the data structure is sometimes referred to as a navigation tree, each branch in the tree defining one or more nodes under a certain category. The hierarchical nodes provide the routes (i.e., the links) between the nodes and allow a user to navigate the tree branches to access content in each category or subcategory.

In certain embodiments of the invention, the navigation tree is a semantic representation of one or more web pages that serve as interactive menu dialogs to support voice-based search by users. Content nodes include content from a web page. Content is included in a node such that when a user visits a node the content is provided to the user. Routing nodes implement options that can be selected to visit other nodes. For example, routing nodes may provide prompts for directing the user to navigate within the tree to access content at content nodes. Thus, routing nodes can link the content of a web page in a meaningful way.

In one or more embodiments, using communication device 110, a user establishes a calling session over communication network 120 with server system 130. Content may be stored on server system 130 or other computing systems connected to it over communication network 120. Application software 222 is executed on server system 130 to cause the system to recognize and process a voice command or query submitted by a user. Upon receiving a voice command, the system attempts to recognize the command. If the voice command is recognized it is then converted into an electronic query. The system then processes and services the query, if possible, by providing the user with access to the requested content. One or more queries may be submitted and processed in a single call.

In order to find the best matching node for a particular user query, the system may search a plurality of nodes in the data structure for one or more search keywords included in the voice query. If a particular content node is the only node in the data structure that includes all of the search keywords, then that node is selected by the system. Otherwise, the system may select a content node that, in combination with the one or more ancestral nodes, includes all of the search keywords. If such node is not found, then the system selects a content node that is the only content node in the data structure that includes at least one of the search keywords.

If more than one content node in the data structure includes at least one of the search keywords, then the system defines a selection set consisting of all nodes in the data structure that include at least one of the search keywords. The system then removes from the selection set respective ancestral nodes that include at least one of the search keywords. The system then prompts the user to select from among the content nodes remaining in the selection set.

In certain embodiments, instead of prompting the user, the system finds a differentiating node in the data structure for each content node in the selection set. A differentiating node is one that is not an ancestral node for other nodes included in the selection set for a particular content node. That is, a differentiating node for a node is an ancestral node unique to that node. Once the differentiating nodes are found, then the system prompts the user to select a differentiating node from a plurality of differentiating nodes for the content nodes included in the selection set. In response to the user selecting a differentiating node, the system then provides the content included in the content node associated with the differentiating node.

In accordance with one aspect of the invention, the system can recognize voice commands that are defined within the boundaries of a navigation grammar. A voice command may include one or more keywords. For a voice command to be recognized, at least one of the keywords needs to be included in the navigation grammar. A navigation grammar includes recognition vocabulary (i.e., a set of keywords) and rules associated with said vocabulary. Once a voice command is received, the application software determines whether one or more of the keywords in the voice command match one or more of the keywords in the grammar's vocabulary. If so, the system then determines the rule associated with the term or phrase and services the request accordingly.

As such, the navigation grammar is defined by the keywords included in the node being visited at each navigation instance, in accordance with one or more embodiments. Depending on implementation, the navigation grammar can be adjusted (e.g., expanded or contracted) at each navigation instance to include keywords in other nodes and to provide more efficient navigation modes. For example, in one or more embodiments, the system provides the user to choose between three different navigation modes: Step mode, Stack mode, and RAN mode. To activate a certain mode, for example, a user provides a directive associated with that mode. A directive is a unique phrase or keyword that can be recognized by the system as a request to activate a certain mode. For example, to activate the RAN mode the user may say “RAN.”

Step Mode:

The Step mode, in some embodiments, is the default navigation mode. Other modes, however, may also be designated as default, if desired. In the Step mode, the navigation grammar comprises a default grammar that includes a default vocabulary and corresponding rules. In accordance with one embodiment, the default grammar is available during all navigation instances. The default grammar may include keywords such as “Help,” “Repeat,” “Home,” “Goto,” “Next,” “Previous,” and “Back.” The Help command activates the Help menu. The Repeat command causes the system to repeat the prompt or greeting for the current node. The Goto command followed by a certain recognizable keyword would cause the system to provide the content included in the node associated with that term. The Home command takes the user back to the root of the navigation tree. Next, Previous, and Back commands cause the system to move to the next or previously visited nodes in the navigation tree.

The above list of keywords is provided by way of example. In some embodiments, the default vocabulary may include none or one of the above keywords, or keywords other than those mentioned above. Some embodiments may be implemented without a default grammar, or a default grammar that includes no vocabulary, for example. In certain embodiments, as the user navigates from one node to the other, the navigation grammar is expanded to further include additional vocabulary and rules associated with one or more nodes visited in the navigation route. For example, in some embodiments, in the Step mode, the grammar at a specific navigation instance comprises vocabulary and rules associated with the currently visited node. In other embodiments, the grammar comprises vocabulary and rules associated with the nodes that are most likely to be accessed by the user at that navigation instance. In some embodiments, the most likely accessible nodes are the visiting node's ancestral nodes or children. As such, in some embodiments, as navigation instances change, so does the navigation grammar.

The grammar, in one embodiment, can be extended to also include the keywords associated with the siblings of the current node. For example, referring to FIG. 2, if the currently visited node is Node 3.2.1, then in the Step mode, the recognition vocabulary includes, for example, the default vocabulary in addition to keywords associated with Node 3.2.1 (the current node), Node 2.2 (the ancestral node), Node 3.2.1.1 and Node 3.2.1.2 (the children node), and Node 3.2.2 (the sibling node). Due to the limited vocabulary available at each navigation instance, the possibility of improper recognition in the Step mode is lower. Because of this limitation, however, to access content in a certain node, the user will have to navigate through the entire route in the navigation tree that leads to the corresponding node.

Limiting the recognition vocabulary and grammar at each navigation instance increases recognition accuracy and efficiency. In some embodiments, to recognize a user utterance or voice command, the system uses a technique that compares a user query with the keywords included in the recognition vocabulary. It is easy to see that if the system has to compare the user's query against all the terms in the recognition vocabulary, then the scope of the search includes all the nodes in the navigation tree.

By limiting the vocabulary, the search scope is narrowed to a certain group of nodes. Effectively, limiting the search scope increases both recognition efficiency and accuracy. The recognition efficiency increases as the system processes and compares a smaller number of terms. The recognition accuracy also increases because the system has a smaller number of recognizable choices and therefore fewer possibilities of mismatching a user utterance with an unintended term in the recognition vocabulary.

In one embodiment, when the system receives a user query, if the system is in the Step mode, then it compares the keywords in user query against the recognition vocabulary associated with the current node. If at least a keyword is recognized, then the system will move to the node associated with the keyword. For example, if the user query includes a keyword associated with a child of the current node, then the system recognizes the keyword and will visit the child node. Otherwise, the query is not recognized.

In the Step mode, the system is highly efficient and accurate because navigation is limited to certain neighboring nodes of the current node. As such, if a user wishes to navigate the navigation tree for content that is included or associated with a node not within the immediate vicinity of the current node, then the system may have to traverse the navigation tree back to the root node. For this reason, the system is implemented such that if the system cannot find a user utterance then the system may switch to a different navigation mode or provide the user with a message suggesting an alternative navigation mode.

Stack Mode:

Some embodiments of the system are implemented to provide another navigation mode called the Stack mode. The Stack mode is a voice navigation model that allows a user to visit any of the previously visited nodes without having to traverse back a branch in the navigation tree. That is, navigation grammar in the stack mode includes the recognition vocabulary and rules encountered during the path of navigation.

In an exemplary embodiment, in Stack mode, the recognition vocabulary comprises keywords associated with the nodes previously visited, when the navigation path includes a plurality of branches of the navigation tree. Thus, in the Stack mode, the user is not limited to moving to one of the children or the ancestral node of the currently visited node, but it can go to any previously visited node. In the Stack mode, the system tracks the path of navigation and expands the navigation grammar by including vocabulary associated with the visited nodes to a stack. A stack is a special type of data structure in which items are removed in the reverse order from that in which they are added, so the most recently added item is the first one removed. Other types of data structures (e.g., queues, arrays, linklists) may be utilized in alternative embodiments.

In some embodiments, the expansion is cumulative. That is, the navigation grammar is expanded to include vocabulary and rules associated with all the nodes visited in the navigation route. In other embodiments, the expansion is non-cumulative. That is, the navigation grammar is expanded to include vocabulary and rules associated with certain nodes visited in the navigation route. As such, in some embodiments, upon visiting a node, the navigation grammar for that navigation instance is updated to remove any keywords and corresponding rules associated with one or more previously visited nodes and their children from the recognition vocabulary.

Because of its limited recognition vocabulary, the Stack mode too provides for accurate recognition but limited navigation options. In some embodiments, the Stack mode is implemented such that the navigation grammar includes more than the above-listed limited vocabulary. For example, certain embodiments may have recognition vocabulary such that the navigation grammar is comprised of the default vocabulary expanded to include the keywords associated with the current node, its neighboring nodes, certain most frequently referenced nodes, and the previously visited nodes in the path of navigation.

RAN Mode:

Rapid Access Navigation or RAN mode is a navigation model for accessing content of Web pages or other sources via a mixed initiative dialogue. In contrast to Step Navigation, where the navigation grammar includes keywords associated with the children of the currently visited node, in RAN mode, the navigation grammar is expanded to include keywords associated with a certain group of nodes that fall within an active navigation scope. In general, the active navigation scope defines the set of nodes that can be directly accessed from the currently visited node.

For example, in certain embodiments, content available on a web site may be represented by a data structure with plurality of nodes, such as navigation tree 200 illustrated in FIG. 2. Depending on implementation all or some nodes in the navigation tree may be within the active navigation scope. If the active navigation scope includes all the nodes, then a user may access content in any node regardless of the position of the currently visited node in the tree. Alternatively, if only a portion of the nodes are within the active navigation scope, then only content included in that portion of the nodes will be directly accessible from the currently visited node. The active navigation scope may, in certain embodiments, depends on the position of the currently visited node within the navigation tree 200.

If the active navigation scope is very broad, a user query for accessing content may result in more than one node being identified as a match for the keywords included in the query. If so, then as provided in further detail below, the system proceeds to resolve this conflict by either determining the context in which the request was provided, or by prompting the user to resolve this conflict. Thus, if the system determines that the RAN mode is activated, then the system expands the navigation grammar to RAN mode grammar defined by the active navigation scope.

RAN mode may be invoked by one or more directives. “Jump to San Francisco traffic,” is an exemplary directive, in accordance with one aspect of the invention. A directive begins with a prefix phrase or keyword (e.g., “jump”) and is followed by one or more filler words or phrases (e.g., “to”), in addition to one or more search keywords (e.g., “San Francisco,” “traffic”). In one or more embodiments, to monitor the search keywords, the system constructs a search-keyword-set that includes the one or more search keywords included in the user query. Insomuch as the search keywords may be interleaved with fillers, the system ignores all filler words or phrases while processing a user query.

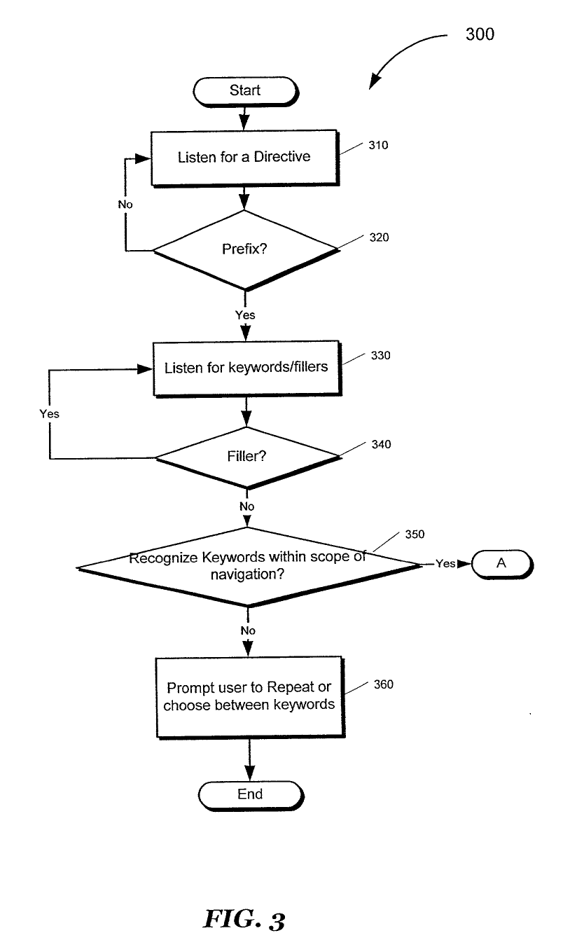

FIG. 3 illustrates a method 300 for processing a user query. When the system receives a user query, at step 310, the system “listens” (i.e., receives audio input) for a RAN directive. To determine if the user intends to invoke the RAN mode, the system monitors user utterances for one or more predefined prefixes (e.g., “jump,” “visit,” etc.). At step 320, if the system detects a predefined prefix, then RAN mode is invoked and at step 330 the system starts listening for search keywords or filler words or phrases. If the system does not detect a predefined prefix, it continues to listen for a RAN directive, at step 310.

In one or more embodiments, the search keywords, prefixes, and the fillers are defined in one or more configuration files, for example. The configuration files are modifiable and can be configured to include search keywords or predefined prefixes or fillers depending on system implementation and/or user preference. Separate configuration parameters may represent sets of keywords or phrases associated with the fillers and the prefixes. For example, a set of filler words may be defined by configuration parameter RANfiller and a set of prefix words may be defined by configuration parameter RANprefix. In one embodiment, the configuration parameters are defined in Java™ Speech Grammar Format (JSGF), in accordance with one or more embodiments.

The JSGF is a platform-independent, vendor-independent textual representation of grammars for use in speech recognition. Grammars are used by speech recognizers to determine what the recognizer should listen for, and so describe the utterances a user may say. JSGF adopts the style and conventions of the Java programming language in addition to use of traditional grammar notations.

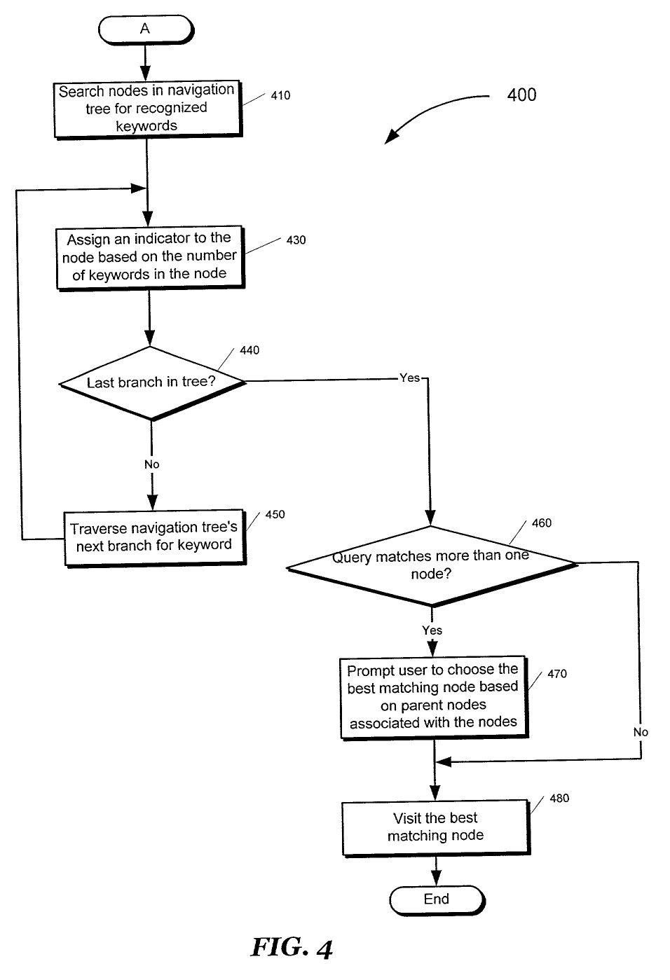

At step 340, if the system detects a filler, it continues to listen, at step 330, for additional words, ignoring the detected filler. At step 350, the system processes the user query to recognize keywords that are within the active scope of navigation. The system assigns a confidence score to each keyword. If based on the assigned confidence score one or more search keywords are recognized, then the system proceeds to step A to find a node that best matches the user query, as illustrated in further detail in FIG. 4.

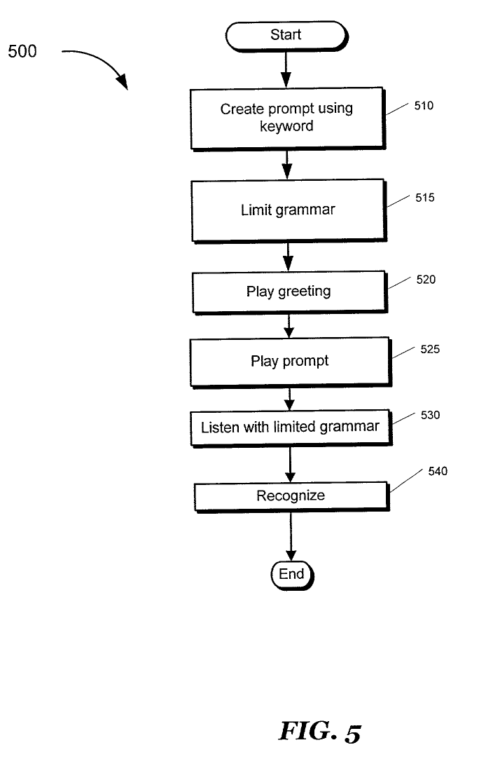

In embodiments of the system, the confidence score assigned to each keyword may not be sufficient to warrant a conclusive or accurate recognition. That is, the system in some instances may be unable to recognize a user utterance with certainty. If so, the system at step 360 prompts the user to repeat or choose between keywords in the navigation grammar to ensure accurate recognition of the keywords. Method 500 illustrated in FIG. 5, and discussed in further detail below, is an exemplary method of resolving ambiguities in recognition based on confidence scores assigned to keywords. Other methods are also possible.

The above implementations of the various navigation modes, including the Stack mode, RAN mode, and the Step mode are provided by way of example. Other modes and implementations may be employed depending on the needs and requirements of the system.

Method for Finding the Best Matching Node

Once the system has successfully recognized keywords included in a user query, the next step is to determine which node in the navigation tree best matches the query. To accomplish this, the system searches branches of the navigation tree to determine whether a node includes one or more keywords that match one or more of the recognized search keywords included in the user query. If a match is detected, the system marks the node as a matching node. In some embodiments, once a matching node is found in a first branch of the navigation tree, the system no longer traverses the first branch, but returns to the branching node and starts traversing a second branch.

Once the system has completed traversing the tree for matching nodes, the best matching node from the marked nodes is selected and the content associated with that node is provided to the user. Various algorithms may be used to determine the best matching node in the navigation tree. In the following an exemplary method 400 is provided. It should be noted, however, that this exemplary method is not to be construed as limiting the scope of the invention, insomuch as other methods may also be implemented to determine the same. It should be further noted that the exemplary method 400 is not limited to RAN mode navigation, but may be utilized in other navigation modes as well.

Referring to FIGS. 2 and 4, in one embodiment, the system at step 410 searches nodes in navigation tree 200 for the recognized search keywords. For example, the system starts at Root node 1.0 and traverses the children or descendant nodes in a first branch (e.g., Portfolios branch) to find matching keywords. If one or more keywords in a node match at least one of the search keywords, the system then marks that node by, for example, setting a flag or assigning an indicator to the node at step 430. The indicator may be a content indicator, in certain embodiments, that indicates the number of matching keywords in the node. In one embodiment, an indicator vector of all zeros indicates no keyword matches.

At step 440 the system determines if the currently traversed branch is the last branch in the navigation tree. If more branches are left, the system continues to traverse the next branch in the navigation tree, at step 450, looking for the search keywords. In some embodiments, even if a matching node is found in one branch, the system continues to traverse other branches, in case another node is a better match for the user query. At step 430, the system assigns an indicator to each node.

Once the system has completed searching all branches, as determined at step 440, the system determines if the user query matches more than one node, at step 460. If only one node matches the query, then that node is the best match and the system at step 480 visits that node. Otherwise, at step 470 the system prompts the user to choose between a plurality of nodes that best match the query. In some embodiments, an indicator value is assigned to each node traversed in the tree. The indicator value indicates the number of matching keywords between a search-keyword-set including the search keywords and a content-keyword-set including the keywords included in the node.

In such embodiment, if more than one node in the tree matches the user query, the indicator value assigned to the node is used to determine the best matching node. That is, the node associated with the highest indicator value (i.e., the node that includes the highest number of search keywords) is selected as the best match.

For the purpose of illustration, assume that a user wants to access San Francisco's weather information and provides a user utterance such as “Is it raining in San Francisco?” If the system processes the utterance to properly recognize all the words in the utterance, a user query including the keyword “San Francisco” will be constructed, as the system will ignore the other terms as fillers. In some embodiments, the system has the intelligence to interpret the term “raining” as related to weather. If so, the user query will also include the keyword “Weather” in addition to “San Francisco.”

Assuming that the query includes the keyword “San Francisco” only, the system searches navigation tree 200 for a node that is the best match for the query. As shown in FIG. 2, content nodes 3.2.1.1 and 3.3.1 are the only nodes in navigation tree 200 that include the keyword “San Francisco.” Thus, the user query is a match for both nodes. To resolve this, the system examines the indicator value for each node. The search-keyword-set in the above example includes the keyword “San Francisco,” and the content-keyword-set for each node also includes “San Francisco.” Therefore, the indicator value for both nodes is equal to 1, as each node includes the only search keyword. Since the indicator value for one node is not larger than the other, one cannot be selected over the other as the best match.

In certain embodiments, to resolve the above multiple-match problem, the system prompts the user to choose between the two nodes 3.2.1.1 and 3.3.1. In constructing the prompt, it is desirable to guide the user with specific information that defines the content in each node. To accomplish this, in one embodiment, the system prompts the user to choose between the nodes based on the ancestral nodes associated with each node. That is, the system constructs a prompt comprising the keywords included in the ancestral nodes. However, some embodiments may not provide such feature.

In the above example, Node 3.2.1.1 is a content node classified under the “News/Traffic” category and Node 3.3.1 is classified under the “Weather” category. Thus, the provided prompt may include the above keywords in order to guide a user to select a category. An exemplary prompt may provide: “Do you want San Francisco Traffic or San Francisco weather?” The user can then respond to the prompt by selecting between one of the categories. For example, if the user responds by saying “Weather” then the system will visit Node 3.3.1 and provides the content associated with that node.

Some embodiments of the system are implemented to resolve the multiple-match problem before resorting to prompting a user for assistance. In such embodiments, the traversed nodes in the navigation tree are associated with one or more indicators. In one embodiment, a node indicator, an ancestral indicator, and a cumulative indicator are calculated for each node. The value of each indicator represents a set of keywords, respectively: a content-keyword-set, an ancestral-keyword-set, and a cumulative-keyword-set.

The content-keyword-set is associated with a content node. It is a subset of the search-keyword-set and includes the keywords included in the content node associated with it. An ancestral-keyword-set is associated with an ancestral node. It is also a subset of the search-keyword-set and includes keywords included in the ancestral node. In some embodiments, an ancestral-keyword-set is associated with a content node. In such embodiments, the ancestral-keyword-set includes keywords contained in one or more ancestral nodes for the content node. The cumulative-keyword-set is associated with a content node or an ancestral node. It is also a subset of the search-keyword-set and includes keywords contained in a node and one or more of its ancestral nodes. That is, the cumulative-keyword-set for a content node is the set that represents the union between the content-keyword-set and the ancestral-keyword-set for the content node.

In accordance with one aspect of the invention, the indicators associated with a node are binary numbers having a length equal to the number of keywords in the search-keyword-set, wherein each digit in the binary number represents the presence or absence of a corresponding search keyword in the node. The digit “1,” for example, may indicate the presence of a keyword. The digit “0,” for example, may indicate the absence of a keyword. For example, if a user utterance is “Get me San Francisco Weather,” then the search-keyword-set includes the search keywords “San Francisco” and “Weather.”

In general, a logic set having members A, B, and C can be represented as “Set=(A,B,C).” Thus, the search-keyword-set can be represented as:

Search-keyword-set=(San Francisco, Weather)

A content node that includes both keywords can be represented or marked with a node indicator having a value of “11” for example. That is, the value of each indicator may be presented in the form of a vector. Thus, for example, a matrix [11] can be used to represent a vector value indicating that both search keywords are included in a node.

A content node that includes the first but not the second keyword can be represented with a node indicator having a value of “10,” and a content node that includes neither keyword can be represented by “00,” for example. It should be noted that the use of binary numbers is one of many possible implementations. Other numeric formats or logical presentations (e.g., vectors, logic sets, geometric presentations) may be utilized, if desired.

The values of the ancestral indicator for a node may be calculated in the same manner. In accordance with one embodiment, if any of the ancestral nodes for a content node include a certain search keyword, then the digit corresponding with that keyword would be set to 1, for example. Referring to FIG. 2, if the search-keyword-set includes “San Francisco” and “Weather,” in that order, then the ancestral indicator for Node 3.2.1.1 would be equal to “00” while the ancestral indicator for Node 3.3.1 would be equal to “01”. A value of “00” indicates that none of the ancestral nodes for Node 3.2.1.1 include either of the two search keywords. A value of “01” indicates that at least one of the ancestral nodes of Node 3.3.1 (e.g., Node 2.3) includes the keyword “Weather.”

In accordance with one embodiment of the invention, a cumulative indicator for a content node represents which search keywords are included in the content node, or at least one of the ancestral nodes for the content node. Accordingly, the cumulative indicator value for each node can be calculated based on the node indicator value and the ancestral indicator value of each node. For example, in one embodiment, the cumulative value for a node is determined by applying a logical AND operation between the node indicator and the ancestral indicator for the node.

Referring to FIG. 2, for example, cumulative indicator for Node 3.2.1.1 and Node 3.3.1 would be respectively equal to “10” and “11” where the search-keyword-set includes “San Francisco” and “Weather,” in that order. Applying a logical AND operation to the digits included in the node indicator and the ancestral indicator provides the cumulative indicator values. In the above example, the node indicator values for Node 3.2.1.1 and Node 3.3.1 are equal to “10” and the ancestral indicator values for Node 3.2.1.1 and Node 3.3.1 are respectively “00” and “0”. The logical AND operation for determining the cumulative indicator value for each node can be represented as follows:

| | | |
|---|---|---|
| Node Indicator | 10 | 10 |
| Ancestral Indicator | 00 | 01 |
| Cumulative Indicator | 10 | 11 |
| (Node Indicator AND Ancestral Indicator) | | |

Once the indicator values for the content nodes in a navigation tree are calculated, the system can process a user query by analyzing and comparing the corresponding indicator values associated with each to determine the best match.

In certain embodiments, the system first compares the node indicators for all content nodes that include at least one search keyword. If the system determines that one content node has a perfect node indicator, that is, if all binary digits in the node indicator are equal to 1, then that node is selected as the best match. Else, if the system determines that one content node has a perfect cumulative indicator, that is, if all search keywords are cumulatively included in either the content node or its parents, then that node is selected as the best match.

Otherwise, the system determines if there are at least one or more content nodes that have a non-zero node indicator, that is, if there are any nodes that include at least one or more of the search keywords. If so, then the system selects the node with the highest number of ones as the best match. The node with the highest number of ones is the node that includes the highest number of search keywords in comparison to the other nodes. Alternately, the system may select the node with the least number of zeros as the best match. If none of the content nodes include at least one of the search keywords, then the system defines a selection set including all nodes in the navigation tree that include at least one of the search keywords. The system then prompts the user to select from among the content nodes in the selection set.

In some embodiments, in order to provide the user with guidance in selecting one of the content nodes from among the nodes in the selection set, the system first finds a differentiating node in the data structure for each content node in the selection set. A differentiating node for a content node is an ancestral node that uniquely identifies the content node. That is, the differentiating node is not an ancestral node associated with other nodes included in the selection set. In some embodiments, the differentiating node is the ancestral node that is closest in hierarchy to the content node. Once a differentiating node for each content node in the selection set is found, then the system constructs a prompt asking a user to select a differentiating node from among plurality of differentiating nodes found for the content nodes.

In some embodiments, the selection set is pruned to include a selected number of content nodes and ancestral nodes, so that the prompt presented would provide a user with a more succinct selection of nodes. Thus, in one embodiment, the system examines all the nodes in the selection set and removes from the selection set all ancestral nodes with a non-zero ancestral indicator. That is, when a user has made an ambiguous selection, the system creates a prompt to disambiguate the original search query (RAN directive). One possible cause for ambiguity is misrecognition by the speech recognition system. Pruning out possibilities reduces the grammar size for a follow-on prompt to the user. A smaller grammar for the follow-on prompt reduces the likelihood that an out-of-grammar (filler) word would accidentally match an in-grammar word. For example, a valid grammar may include NFL teams (e.g. “Bears, Falcons, 49ers, . . . ”) and recreational fishing and hunting (e.g., “deer, duck, salmon, trout, . . . ”). If the user vocalizes “Jump to deer hunting,” “deer” might be misrecognized as “Bears,” thereby creating ambiguity for which the system would need to present a follow-on prompt. This follow-up prompt could be “Did you want Chicago Bears or Hunting?,” with a grammar which includes only “bears” and “hunting.” This step, in some embodiments, takes place prior to finding a differentiating node for each content node in the selection set. As such, the number of possible matches presented to the user for selection is reduced. Once the user selects a differentiating node, the system provides the content included in the node associate with it.

Referring back to FIG. 2, for illustration purposes consider the following keyword-search-set provided to the system for selecting the best matching node in navigation tree 200:

keyword-search-set=(Business, News, Dow Jones)

In one embodiments, to select the best match, the system first determines the node indicator values for some or all the nodes. The keyword-search-set has three members, thus the length of the node indicator for each node is three. All nodes other than nodes 3.1.1, 2.2, 3.2.2, and 3.2.2.1 have node indicator values represented by vector value [000], because those other nodes do not include any of the keywords in the keyword-search-set. The node indicator vector (NIV) values for the above nodes are:

NIV_{3.1.1}=[001]

NIV_{2.2}=[010]

NIV_{3.2.2}=[110]

NIV_{3.2.2 1}=[001]

A perfect NIV value is a vector including all ones, such as [111], for example. Since none of the nodes have a perfect NIV value, then the system also determines the cumulative indicator values (CIV) for some or all nodes in navigation tree 200. The CIVs for the above nodes are:

CIV_{3.1.1}=[001]

CIV_{2.2}=[010]

CIV_{3.2.2}=[110]

CIV_{3.2 2.1}=[111]

Since Content Node 3.2.2.1 has a perfect CIV value, the system will select this node as the best match. To continue with the same example, however, assume that the system does not find the best match at this point. To find the best match, the system defines a selection set including all nodes in the navigation tree that include at least one of the search keywords. The selection set can be represented as follows:

Selection Set=(Node_{3.1.1}, Node_{2.2}, Node_{3.2.2}, Node_{3.2.2}.)

The system then processes the members of the selection set and, so long as a node included in the set has a non-zero ancestral indicator value, the system removes any ancestral node with a non-zero NIV from the selection set. Thus, in this example, the system removes Node 2.2 and Node 3.2.2 from the selection set. The selection set can now be represented as follows:

Selection Set=(Node_{3 1.1}, Node_{3.2.2.1})

As such, the selection set is narrowed to include the two content nodes in the navigation tree that are the best matches for the user query. The system in some embodiments finds the highest differentiating ancestral node for each node in the selection set and uses a keyword associated with the ancestral node to construct a prompt. The respective highest differentiating ancestral node for nodes 3.1.1 and 3.2.2.1 are nodes 2.1 and 3.2.2. Thus, the system may provide the following prompt to the user: “Do you want the Dow Jones under Portfolios or Business News category?”

In accordance with another aspect of the invention, to access content stored in a data structure, the system searches a plurality of content nodes in the data structure for one or more search keywords included in a voice command or user query. The system then finds a first node, in the plurality of content nodes, that includes all the search keywords. The system then provides content included in the first node, if the first node is the node that includes all of the search keywords. If a second node, however, also includes all the keywords included in the first node, the system prompts the user to select between the first node and the second node. The system then provides content included in the node selected by the user.

In embodiments of the system, the search keywords are included in the user query in a first order. If none of the nodes included in the data structure include all the search keywords, then the system finds the nodes in the data structure that include the highest number of search keywords. To accomplish this, the system associates each node with a node indicator representing the number of search keywords included in the node in the first order. The system then compares a first node indicator (associated with a first node) with a second node indicator (associated with a second node).

Thereafter, the system provides the content included in the first node, if the first node indicator is greater than the second node indicator; otherwise, the system provides the content included in the second node, if the first node indicator is less than the second node indicator. If the first node indicator is equal to the second node indicator, the system determines a first ancestral indicator for the first node representing the number of search keywords included in a first set of ancestral nodes related to the first node. The system then determines a second ancestral indicator for the second node representing the number of search keywords included in a second set of ancestral nodes related to the second node.

The system then compares the first ancestral indicator with the second ancestral node indicator and provides content included in the first node, if the first ancestral indicator is greater than the second ancestral node indicator. The system provides the content included in the second node, if the first ancestral indicator is less than the second ancestral node indicator. If the first and second ancestral node indicators are equal the system then prompts the user to choose between the first and the second node as provided above.

In some embodiments, the system calculates a first cumulative indicator from the first node indicator and the first ancestral indicator, such that the first cumulative indicator represents the number of search keywords included in the first node and its ancestral nodes. The system also calculates a second cumulative indicator from the second node indicator and the second ancestral indicator. Thereafter, the system provides content included in the first node, if the first cumulative indicator is greater than the second cumulative indicator; or provides the content included in the second node, if the first cumulative indicator is less than the second cumulative indicator.

In one embodiment, the system prompts a user to select between the first node and the second node, if the second cumulative indicator is equal to the first cumulative node. The system then provides the content included in a node selected by the user, in response to the user selecting between the first node and the second node.

The above methods for selecting the best matching node are among many exemplary methods that can be implemented. Other embodiments of the system, may utilize other or modified version of this method. Therefore, the methods provided here should not be construed as a limitation.

Method For Resolving Recognition Ambiguity

FIG. 5 is a flow diagram of an exemplary method 500 for resolving recognition ambiguity. As briefly discussed earlier, when a user utterance is received by the system, to recognize keywords within the active scope of navigation, the system assigns a confidence score to the recognition results of each utterance. Unlike the indicator values, described earlier, that are used for finding the best matching node for a recognized user utterance, the confidence score is used to determine if the user utterance is properly recognized. The confidence score is assigned based on how close of a match the system has been able to find for the user utterance in the recognition vocabulary.

In embodiments of the system, to compare a user utterance against the recognition vocabulary, the user utterance or the keywords included in the utterance are broken down into one or more phonetic elements. A user utterance is, typically, received in the form of an audio input, wherein different portions of the audio input represent one or more keywords or phrases. A phonetic element is the smallest phonetic unit in each audio input that can be broken down based on pronunciation rather than spelling. In some embodiments, the phonetic elements for each utterance are calculated based on the number of syllables in the request. For example, the word “weather” may be broken down into two phonetic elements: “wê” and “thê.”

The phonetic elements specify allowable phonetic sequences against which a received user utterance may be compared. Mathematical models for each phonetic sequence are stored in a database. When a user utterance is received by the system, the utterance is compared against all possible phonetic sequences in the database. A confidence score is computed based on the probability of the utterance matching a phonetic sequence. A confidence score, for example, is highest if a phonetic sequence best matches the utterance. For a detailed study on this topic please refer to “F. Jelinek, Statistical Methods for Speech Recognition, MIT Press, Cambridge, Mass. 1997.”

In one embodiment, for any recognition, the confidence score calculated for a user utterance is compared with a rejection threshold. A rejection threshold is a value that indicates whether a selected phonetic sequence from the database can be considered as the correct match for the utterance. If the confidence score is higher than the rejection threshold, then that is an indication that a match may have been found. However, if the confidence score is lower than the rejection threshold, that is an indication that a match is not found. If a match is not found, then the system provides the user with a rejection message and handles the rejection by, for example, giving the user another chance to utter a new voice command or query.

The recognition threshold is a number or value that indicates whether a user utterance has been exactly or closely matched with a phonetic sequence that represents a keyword included in the grammar's vocabulary. If the confidence score is less than the recognition threshold but greater than the rejection threshold, then a match may have been found for the user utterance. If, however, the confidence score is higher than the recognition threshold, then that is an indication that a match has been found with a high degree of certainty. Thus, if the confidence score is not between the rejection and recognition thresholds, then the system either rejects or recognizes the user utterance.

Otherwise, if the confidence score is between the recognition threshold and the rejection threshold, then the system attempts to determine with a higher degree of certainty whether a correct match can be selected. That is, the system provides the user with the best match or best matches found and prompts the user to confirm the correctness or accuracy of the matches.

Referring to FIG. 5, at step 510, the system builds a prompt using the keywords included in the user utterance. Then, at step 515, the system limits the system's vocabulary to “yes” or “no” or to the matches found for the request.

At step 520, the system plays the greeting for the current node. For example, the system may play: “You are at Weather.” The greeting may also include an indication that the system has encountered an obstacle and that the user utterance cannot be recognized with certainty and therefore, it will have to resolve the ambiguity by asking the user a number of questions. At step 525, the system plays the prompt. The prompt may ask the user to repeat the request or to confirm whether a match found for the request is the one intended by the user.

In certain embodiments, to maximize the chances of recognition, the system may limit the system's vocabulary at step 515 to the matches found. At step 530, the system accepts audio input with limited grammar to receive another user utterance or confirmation from the user. The system then repeats the recognition process and if it finds a close match from among the limited vocabulary, then the user utterance is recognized at step 540.

The order in which the steps of the present method is performed is purely illustrative in nature. The steps can be performed in any order or in parallel, unless indicated otherwise by the present disclosure. The method of the present invention may be performed in either hardware, software, or any combination thereof, as those terms are currently known in the art. In particular, the present method may be carried out by software, firmware, or macrocode operating on a computer or computers of any type.

Additionally, software embodying the present invention may comprise computer instructions in any form (e.g., ROM, RAM, magnetic media, punched tape or card, compact disk (CD) in any form, DVD, etc.). Furthermore, such software may also be in the form of a computer signal embodied in a carrier wave, such as that found within the well-known Web pages transferred among computers connected to the Internet. Accordingly, the present invention is not limited to any particular platform, unless specifically stated otherwise in the present disclosure.

Hardware & Software Environments

In accordance with one or more embodiments, the system is implemented in two environments, a software environment and a hardware environment. The hardware includes the machinery and equipment that provide an execution environment for the software. The software provides the execution instructions for the hardware.

The software can be divided into two major classes: system software and application software. System software includes control programs, such as the operating system (OS) and information management systems that instruct the hardware how to function and process information. Application software is a program that performs a specific task. As provided herein, in embodiments of the invention, system and application software are implemented and executed on one or more hardware environments.

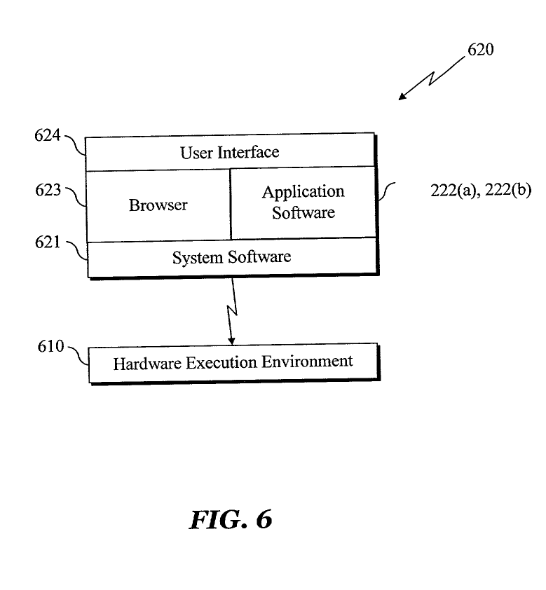

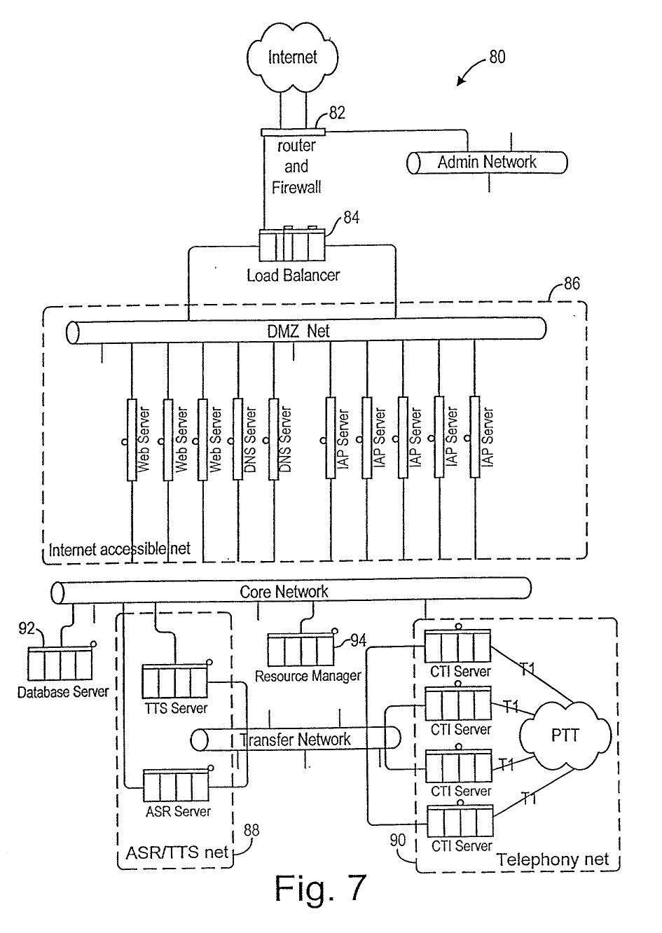

The invention may be practiced either individually or in combination with suitable hardware or software architectures or environments. For example, referring to FIG. 1, communication device 110 and server system 130 may be implemented in association with hardware embodiment illustrated in FIG. 7. Application software 222 for providing a voice navigation method may be implemented in association with one or multiple modules as a part of software system 620, illustrated in FIG. 6. It may prove advantageous to construct a specialized apparatus to execute said modules by way of dedicated computer systems with hardwired logic code stored in non-volatile memory, such as, by way of example, read-only memory (ROM).

Software Environment

FIG. 6 illustrates exemplary computer software 620 suited for managing and directing the operation of the hardware environment described below. Computer software 620 is, typically, stored in storage media and is loaded into memory prior to execution. Computer software 620 may comprise system software 621 and application software 222. System software 621 includes control software such as an operating system that controls the low-level operations of computing system 610. In one or more embodiments of the invention, the operating system can be Microsoft Windows 2000,® Microsoft Windows NT,® Macintosh OS,® UNIX,® LINUX,® or any other suitable operating system.

Application software 222 can include one or more computer programs that are executed on top of system software 621 after being loaded from storage media 606 into memory 602. In a client-server architecture, application software 222 may include a client software 222(a) and/or a server software 222(b). Referring to FIG. 1 for example, in one embodiment of the invention, client software 222(a) is executed on communication device 110 and server software 222(b) is executed on server system 130. Computer software 620 may also include web browser software 623 for browsing the Internet. Further, computer software 620 includes a user interface 624 for receiving user commands and data and delivering content or prompts to a user.

Hardware Environment

An embodiment of the system can be implemented as application software 222 in the form of computer readable code executed on general purpose computing systems and networks. FIG. 7 illustrates a computer-based system 80 which is an exemplary hardware implementation for voice navigation system of the present invention. In general, computer-based system 80 may include, among other things, a number of processing facilities, storage facilities, and work stations.

As depicted, computer-based system 80 comprises a router/firewall 82, a load balancer 84, an Internet accessible network 86, an automated speech recognition (ASR)/text-to-speech (TTS) network 88, a telephony network 90, a database server 92, and a resource manager 94.

These computer-based system 80 may be deployed as a cluster of networked servers. Other clusters of similarly configured servers may be used to provide redundant processing resources for fault recovery. In one embodiment, each server may comprise a rack-mounted Intel Pentium processing system running Windows NT, Linux OS, UNIX, or any other suitable operating system.

For purposes of the present invention, the primary processing servers are included in Internet accessible network 86, automated speech recognition (ASR)/text-to-speech (TTS) network 88, and telephony network 90. In particular, Internet accessible network 86 comprises one or more Internet access platform (IAP) servers. Each IAP server implements the browser functionality that retrieves and parses conventional markup language documents supporting web pages. Each IAP server builds one or more navigation trees (which are the semantic representations of the web pages) and generates navigation dialogs with users.

Telephony network 90 comprises one or more computer telephony interface (CTI) servers. Each CTI server connects the cluster to the telephone network which handles all call processing. ASR/TTS network 88 comprises one or more automatic speech recognition (ASR) servers and text-to-speech (TTS) servers. ASR and TTS servers are used to interface the text-based input/output of the IAP servers with the CTI servers. Each TTS server can also play digital audio data.

Load balancer 84 and resource manager 94 may cooperate to balance the computational load throughout computer-based system and provide fault recovery. For example, when a CTI server receives an incoming call, resource manager 94 assigns resources (e.g., ASR server, TTS server, and/or IAP server) to handle the call. Resource manager 94 periodically monitors the status of each call and in the event of a server failure, new servers can be dynamically assigned to replace failed components. Load balancer 84 provides load balancing to maximize resource utilization, reducing hardware and operating costs.

Computer-based system 80 may have a modular architecture. An advantage of this modular architecture is flexibility. Any of these core servers—i.e., IAP servers, CTI servers, ASR servers, and TTS servers—can be rapidly upgraded ensuring that voice browsing system 10 always incorporate the most up-to-date technologies.

Although particular embodiments of the present invention have been shown and described, it will be obvious to those skilled in the art that changes and modifications may be made without departing from the present invention in its broader aspects, and therefore, the appended claims are to encompass within their scope all such changes and modifications that fall within the true scope of the present invention.

1. A method of navigating a data structure comprising a plurality of nodes, each node associated with content from a content source and at least a keyword defining the content, said method comprising:
receiving a voice query to access content associated with one of said plurality of nodes,
recognizing one or more search keywords in the voice query based on a navigation grammar defined by a first active navigation scope associated with a first set of nodes in the data structure;
searching the first set of nodes to find a node with one or more keywords that best match the search keywords; and
visiting the node with one or more keywords that best matches the search keywords.

2. The method of claim 1, further comprising:
providing content included in the visited node.

3. The method of claim 2, wherein the content source is a web site.

4. The method of claim 3, wherein content included in each node is associated with content included in a web page within the web site.

5. The method of claim 4, wherein the first active navigation scope defines content within a web page that is accessible at the time the voice query is received.

6. The method of claim 1, wherein the plurality of nodes are linked in a hierarchical arrangement defined by the content of a web site, the method further comprising:
defining a second navigation scope based on the position of the visited node within the hierarchical arrangement, the second navigation scope associated with a second set of nodes in the data structure.

7. A computer-readable medium comprising program code for navigating a data structure comprising a plurality of nodes, each node associated with content from a content source and at least one keyword defining the content, the program code comprising:
logic code configured to cause a computing system to receive a voice query to access content associated with one of said plurality of nodes;
logic code configured to cause a computing system to recognize one or more search keywords in the voice query based on a navigation grammar defined by the first active navigation scope;
logic code configured to cause a computing system to search the first set of nodes to find a node with one or more keywords that best match the search keywords; and
logic code configured to cause a computing system to provide the content included in the node with one or more keywords that best matches the search keywords.

8. The computer readable medium of claim 7, wherein the plurality of nodes are linked in a hierarchical arrangement defined by the content of the web site, the program code further comprising:
logic code configured to cause a computing system to define a second navigation scope based on the position of the node that best matches the search keyword within the hierarchical arrangement, the second navigation scope associated with a second set of nodes in the data structure

9. A system for navigating a data structure comprising a plurality of nodes, each node associated with content from a content source and at least a keyword defining the content, said system comprising:
means for receiving a voice query to access content in one of said plurality of nodes;
means for recognizing one or more search keywords in the voice query based on a navigation grammar defined by a first active navigation scope associated with a first set of nodes in the data structure;
means for searching the first set of nodes to find a node with one or more keywords that best match the search keywords; and
means for visiting the node that best matches the search keyword.

10. The system of claim 9, wherein the plurality of nodes are linked in a hierarchical arrangement defined by the content of the web site, the system further comprising:
means for defining a second navigation scope based on the position of the node that best matches the search keyword within the hierarchical arrangement, the second navigation scope associated with a second set of nodes in the data structure.

11. A method for selecting a node from a plurality of content nodes in a data structure, each node linked to one or more respective ancestral nodes based on a hierarchical relationship which defines the data structure, each node comprising one or more keywords, the method comprising:
searching a plurality of content nodes in a data structure for one or more search keywords included in a voice command;
if a particular content node is the only content node in the data structure that includes all the search keywords, selecting that content node; otherwise
if a particular content node is the only content node in the data structure that in combination with its one or more respective ancestral nodes includes all the search keywords, selecting that content node; otherwise
if a particular content node is the only content node in the data structure that includes at least one of the search keywords, selecting that content node.

12. The method of claim 11, wherein the voice command further comprises one or more filler words, the method further comprising:
filtering the filler words out of the voice command.

13. The method of claim 11, wherein one or more content nodes in the data structure are linked to common ancestral nodes, and wherein more than one content node in the data structure includes at least one of the search keywords, the method further comprising:
defining a selection set comprising all nodes in the data structure that have at least one of the search keywords; and
removing from the selection set any ancestral nodes that include at least one of the search keywords.

14. The method of claim 13, further comprising:
prompting a user to select from among the content nodes in the selection set.

15. The method of claim 13, the method further comprising:
identifying a differentiating node in the data structure for each content node in the selection set,
wherein the differentiating node for each node is not an ancestral node for other nodes included in the selection set.

16. The method of claim 15, further comprising:
prompting a user to select a differentiating node from a plurality of differentiating nodes for the content nodes included in the selection set.

17. The method of claim 16, further comprising:
selecting the content node associated with the selected differentiating node.

18. The method of claim 11, wherein each node in the data structure is associated with a node indicator that identifies the search keywords included in the node.

19. The method of claim 18, wherein each node in the data structure is associated with an ancestral node indicator that identifies the search keywords included in the one or more respective ancestral nodes for the node.

20. The method of claim 19, wherein the node indicator and the ancestral node indicator are each represented by a respective combination of digits, each digit corresponding with a particular search keyword, number of the digits in each respective combination being equal to number of the search keywords, each digit indicating whether or not the node or the one or more respective ancestral nodes for the node include a corresponding search keyword.

21. A method of accessing content stored in a data structure comprising:
searching a plurality of content nodes arranged in a hierarchical order in a data structure for one or more keywords, in response to receiving a voice command including said one or more keywords in a first order;
comparing a first node indicator value for a first node with a second node indicator value for a second node, wherein the first node and the second node include the highest number of said one or more keywords, and wherein the respective node indicator value for each node represents the number of said one or more keywords included in each node in the first order;
providing content included in the first node, if the first node indicator value is greater than the second node indicator value; and
providing content included the second node, if the first node indicator value is less than the second node indicator value.

22. The method of claim 21, further comprising:
providing content included in the first node, if the first node is the only node comprising all of said one or more keywords;
prompting a user to select between the first node and a second node in the plurality of content nodes, if the second node also comprises all said one or more keywords; and
providing content included in the first node or the second node in response to the user selecting between the first node and the second node.

23. The method of claim 21, wherein the first node indicator is equal to the second node indicator, the method further comprising:
determining a first ancestral indicator value for the first node representing number of said one or more keywords included in a first set of ancestral nodes related to the first node, in the first order; and
determining a second ancestral indicator value for the second node representing number of said one or more keywords included in a second set of ancestral nodes related to the second node, in the first order.

24. The method of claim 23, further comprising:
comparing the first ancestral indicator value with the second ancestral node indicator value;
providing content included in the first node, if the first ancestral indicator value is greater than the second ancestral node indicator value; and
providing content included in the second node, if the first ancestral indicator value is less than the second ancestral node indicator value.

25. The method of claim 23, further comprising:
calculating a first cumulative indicator value from the first node indicator and the first ancestral indicator value, the first cumulative indicator value representing number of said one or more keywords included in the first node and the first set of ancestral nodes, in the first order; and
calculating a second cumulative indicator from the second node indicator and the second ancestral indicator, the second cumulative indicator representing number of said one or more keywords included in the second node and the second set of ancestral nodes, in the first order.

26. The method of claim 25, further comprising:
providing content included in the first node, if the first cumulative indicator value is greater than the second cumulative indicator value; and
providing content included the second node, if the first cumulative indicator value is less than the second cumulative indicator value.

27. The method of claim 25, further comprising:
prompting a user to select between the first node and the second node, if the second cumulative indicator value is equal to the first cumulative indicator value; and
providing content included in a node selected by the user, in response to the user selecting between the first node and the second node.

28. The method of claim 25, wherein the first node indicator value is represented by a combination of digits, each digit corresponding to a respective one of said one or more keywords and whether or not the respective keyword is included in the first node.

29. The method of claim 28, wherein the first ancestral indicator value is represented by a combination of digits, each digit corresponding to a respective one of said one or more keywords and whether or not the respective keyword is included in the first set of ancestral nodes.

30. The method of claim 29, wherein the first node indicator value and the first ancestral indicator value are represented by binary numbers, and wherein each digit in the first cumulative indicator value is calculated by applying a logical AND operation to each of the respective individual digits in the first node indicator value and the first ancestral indicator value.

31. A voice operated system for accessing content accessible from one or more sources, the system comprising:
a data structure implemented to provide access to content included in a plurality of content nodes, each content node associated with one or more ancestral nodes linked in an arrangement that defines a hierarchy for the content;
a voice interface for searching the data structure for one or more keywords included in a search-keyword-set and for further providing content included in a content node associated with at least one of said one or more keywords; and
a plurality of node indicators, each node indicator provided for a respective content node and representing a content-keyword-set that is a subset of the search-keyword-set, each content-keyword-set including one or more keywords related to content associated with the respective content node;
wherein content associated with a particular content node is provided, if the respective content-keyword-set for other content nodes are subsets of the respective content-keyword-set for the particular content node.

32. The system of claim 31, wherein the content associated with a content node is provided, if the respective node indicator for the content node is equivalent to the search-keyword-set.

33. The system of claim 31, further comprising:
a plurality of ancestral indicators, each ancestral indicator provided for a respective content node and representing a respective ancestral-keyword-set that is a subset of the search-keyword-set, each ancestral-keyword-set including one or more keywords associated with the respective ancestral nodes for the respective ancestral indicator for each content node, the ancestral indicator representing an ancestral-keyword-set that is a subset of the search-keyword-set and includes one or more keywords associated with ancestral nodes of content node;
wherein the content associated with a particular content node is provided, if the ancestral-keyword-sets for other content nodes are subsets of the ancestral-keyword-set for the particular content node.

34. The system of claim 33, wherein a respective ancestral-keyword-set for each content node further includes keywords included in the content-keyword-set for the respective content node.

35. The system of claim 31, wherein the content-keyword-sets for all content nodes in the data structure are not subsets of the content-keyword-set for the first content node, the system further comprising:
an ancestral indicator for each content node, the ancestral indicator representing an ancestral-keyword-set that is a subset of the search-keyword-set and includes one or more keywords associated with ancestral nodes of each content node;
a cumulative indicator for each node, the cumulative indicator representing a cumulative-keyword-set derived from a union between the content-keyword-set and the ancestral-keyword-set;
wherein the content associated with a first content node is provided, if the cumulative-keyword-sets for all other content nodes in the data structure are subsets of the cumulative-keyword-set for the first content node.

36. The system of claim 35, wherein the system prompts a user to select from among the first node and one or more other nodes in the data structure, if the cumulative-keyword-set for the first node is equivalent to the cumulative-keyword-set for the one or other more nodes.

37. The system of claim 31, wherein the node indicator is a binary number comprising one or more digits, each digit corresponding to a keyword included in the content-keyword-set.

38. The system of claim 33, wherein the ancestral indicator is a binary number comprising one or more digits, each digit corresponding to a keyword included in the ancestral-keyword-set.

39. The system of claim 35, wherein the cumulative indicator is a binary number comprising one or more digits, each digit corresponding to a keyword included in the cumulative-keyword-set.

40. The system of claim 37, wherein length of the binary number is equal to the number of keywords included in the search-keyword-set, each digit in the binary number indicating the presence or lack of presence of a corresponding keyword in the content-keyword-set.

41. The system of claim 38, wherein length of the binary number is equal to the number of keywords included in the search-keyword-set, each digit in the binary number indicating the presence or lack of presence of a corresponding keyword in the ancestral-keyword-set.

42. The system of claim 39, wherein length of the binary number is equal to the number of keywords included in the search-keyword-set, each digit in the binary number indicating the presence or lack of presence of a corresponding keyword in the cumulative-keyword-set.

43. The method of claim 1, further comprising:
invoking a first navigation mode, in response to receiving a directive comprising a prefix, one or more fillers and one or more search keywords, wherein the prefix indicates the mode of navigation.

44. The method of claim 43, further comprising:
filtering out the search keywords from the directive by ignoring the fillers.

45. The method of claim 44, wherein the prefix is positioned at the beginning of the directive.

46. A method for navigating a data structure comprising a plurality of nodes, each node associated with respective content, wherein content associated with each respective node is accessible when a node is visited, the method comprising:
providing a choice for navigating the data structure in a first navigation mode, the first navigation mode associated with a first navigation grammar; and
navigating of the data structure, in response to a user command, in a second navigation mode, wherein the second navigation mode is associated with a second navigation grammar.

47. The method of claim 46, wherein one of the first or second navigation modes comprises a step mode of navigation associated with a navigation grammar comprising:
vocabulary and navigation rules associated with a currently visited node and the visiting node's immediate children or ancestral nodes.

48. The method of claim 46, wherein one of the first or second navigation modes comprises a stack mode of navigation associated with a navigation grammar comprising:
vocabulary and navigation rules associated with a currently visited node and all nodes visited prior to visiting the current node.

49. The method of claim 46, wherein one of the first or second navigation modes comprises a RAN mode of navigation associated with a navigation grammar comprising:
vocabulary and navigation rules associated with a currently visited node and all nodes within a scope of navigation.

50. A voice navigation system for navigating a data structure comprising a plurality of nodes, each node associated with respective content, wherein content associated with each respective node is accessible when a node is visited, the system providing one or more selectable navigation modes for visiting the plurality of nodes in the data structure, wherein each navigation mode is associated with a respective navigation grammar, wherein a user may select a navigation mode by issuing a command.

51. The system of claim 50, wherein one of the plurality of navigation modes comprises a step mode of navigation associated with a navigation grammar comprising:
vocabulary and navigation rules associated with a currently visited node and the visiting node's immediate children or ancestral nodes.

52. The system of claim 50, wherein one of the plurality of navigation modes comprises a stack mode of navigation associated with a navigation grammar comprising:
vocabulary and navigation rules associated with a currently visited node and all nodes visited prior to visiting the current node.

53. The method of claim 50, wherein one of the plurality of navigation modes comprises a RAN mode of navigation associated with a navigation grammar comprising:
vocabulary and navigation rules associated with a currently visited node and all nodes within a scope of navigation.

54. A method of accessing content stored in a data structure comprising:
searching a plurality of content nodes arranged in a hierarchical order in a data structure for one or more keywords, in response to receiving a voice command including said one or more keywords in a first order;
determining a respective node indicator value for each content node, each respective node indicator value representing the number of said one or more keywords included in the respective content node; and
initiating a disambiguation process if the highest node indicator value does not exceed a predetermined threshold.

55. The method of claim 54, wherein the predetermined threshold is an absolute value.

56. The method of claim 54, wherein the predetermined threshold is a predetermined value for a difference between the two highest node indicator values.

57. The method of claim 56, further comprising comparing a first node indicator value for a first node with a second node indicator value for a second node, wherein the first node and the second node include the highest number of said one or more keywords.
